(19) United States
(12) Patent Application Publication
(10) Pub. No.: US 2018/0184669 A1
(43) Pub. Date: Jul. 5, 2018

(54) BAKING OVEN WITH A CONVECTION FAN

(71) Applicant: HAAS FOOD EQUIPMENT GMBH, WIEN (AT)

(72) Inventors: JOHANNES HAAS, WIEN (AT); JOSEF HAAS, LEOBENDORF (AT); STEFAN JIRASCHEK, KOENIGSBRUNN (AT); MARKUS SCHELLER, BRUDERNDORF (AT)

(21) Appl. No.: 15/580,720

(22) PCT Filed: Jun. 7, 2016
(86) PCT No.: PCT/EP2016/062848

§ 371 Date: Dec. 8, 2017

(30) Foreign Application Priority Data
Jun. 8, 2015 (EP) 15171027.4

(51) Int. Cl. A21B 3/04; A21B 1/28; A21B 1/48; A21B 3/07; A21B 3/13

(52) U.S. Cl. CPC A21B 3/04; A21B 1/28; A21B 3/135; A21B 3/07; A21B 1/48

(57) ABSTRACT

A baking oven for producing baked, preferably edible products, includes a plurality of openable and closable baking tongs provided along an endless conveyor, disposed consecutively in a row and passing through a baking mass application zone for application of a baking mass to an opened baking tong, a closing zone for closing the baking tongs, a baking chamber for baking the baked products in the closed baking tongs in which at least one heating configuration for heating the baking tongs located in the baking chamber is provided, an opening zone for opening the baking tongs and a baked product removal zone for removing the baked products from the opened baking tongs. At least one convection fan is provided which opens into the baking chamber at a distance from an extractor.

The invention relates to a baking oven according to the generic term of the independent patent claim.

Baking ovens, in particular baking ovens for the industrial production of baked products such as for example for the industrial production of wafers, are known and published in different embodiments.

For example, so-called baking tong ovens are known in which openable and closable baking tongs are conveyed continuously along an endless conveyor. In this case, the baking tongs are conveyed along the course of the endless conveyor through a baking chamber and through a pre-head of the baking oven substantially separate from the baking chamber. In this pre-head the baking tongs are opened, the baked product is then removed, the baking tongs are then loaded with a dough or a baking mass once more, closed again and subsequently conveyed once more through the baking chamber.

In order to improve the efficiency of the baking ovens, it is known to provide the walls of the baking chamber with a thermal insulation over its entire area. The heat loss can thus be reduced.

According to more recent developments, radiant burners are used in addition to simple gas burners or instead of simple gas burners for heating the baking chamber. For further improvement it is also known to design the baking chamber to be substantially closed. This means that unlike conventional baking ovens, the underside of the baking chamber is also closed and is preferably provided with a thermal insulation.

With a combination of a closed baking chamber and efficient heating device, it can occur that the radiant burners operated for example exclusively with primary air produce too little gas or air throughput with the result that sufficient flow through the combustion chamber is not achieved.

It is now the object of the invention to improve conventional baking ovens. This comprises in particular that the energy efficiency of the baking oven is improved. Furthermore, however the baking quality can also be improved by the present invention.

The object according to the invention is solved in particular by the feature combination of the independent patent claim.

Optionally the invention relates to a baking oven for producing baked, preferably edible products, comprising a plurality of openable and closable baking tongs provided along an endless conveyor, which each arranged in a row consecutively pass through:

a baking mass application zone for application of a baking mass to an opened baking tong,

a closing zone for closing the baking tongs,

a baking chamber for baking the baked products in the closed baking tongs,

an opening zone for opening the baking tongs

and a baked product removal zone for removing the baked products from the opened baking tongs,

wherein the endless conveyor and the baking tongs are deflected at a rear deflection point arranged in the baking chamber and at a front deflection point arranged at a distance from the baking chamber in a pre-head, wherein the baking chamber is configured as a substantially closed baking chamber having a thermal insulation, which comprises an inlet opening for entry of the baking tongs, an outlet opening for exit of the baking tongs and an extractor for extracting the combustion chamber gases, wherein at least one convection fan is provided which opens into the baking chamber at a distance from the extractor.

Optionally it is provided that the convection fan is an air blower via which air, in particular secondary air or exclusively secondary air, can be introduced into the baking chamber in a controlled or regulated manner to produce artificial convection.

Optionally it is provided that the convection fan and its convection flow open into the baking chamber in the area of the rear deflection point or through the rear end wall of the baking chamber.

Optionally it is provided that the convection fan and its convection flow open into the baking chamber in the area of the rear deflection point or through the rear end wall of the baking chamber and that the convection flow in the baking chamber runs along the main direction of movement of the baking tongs and in particular substantially horizontally before it exits from the extractor.

Optionally it is provided in all embodiments that along the convection flow of the convection fan, flow takes place firstly through the opening of the convection fan into the combustion chamber, then the region of the combustion chamber in which the heating arrangement is provided and then the extractor or these are arranged in this order.

Optionally it is provided that a convection zone in which no heating arrangement is provided, is provided between the or a region in which the or a heating arrangement is provided and an or the extractor.

Optionally it is provided that the extractor, when viewed along the main direction of movement of the baking tongs, opens into the baking chamber at a distance from the rear deflection point on the other side of the baking chamber and in particular close to the pre-head.

Optionally it is provided that at least one heating arrangement for heating the baking tongs located in the baking chamber is provided in the baking chamber.

Optionally it is provided that the heating arrangement contains or is a radiant heating device wherein the radiant heating device is in particular a wire mesh burner or a porous burner.

Optionally it is provided that the heating arrangement contains or is a radiant heating device wherein the radiant heating device is in particular a wire mesh burner or a porous burner and that the radiant heating device comprises a combustion zone for combustion of a pre-mixed air-fuel mixture, wherein the air of the air-fuel mixture is in particular the primary air for combustion of the fuel.

Optionally it is provided that an extraction fan for extraction of the combustion chamber gas through the extractor is provided.

Optionally it is provided that two or more convection fans are provided which open into the baking chamber separately from one another at different points.

Optionally it is provided that two or more convection fans are provided which open into the baking chamber separately from one another at different points and which open into the baking chamber in particular in the region of the rear deflection point or through the rear end wall of the baking chamber.

Optionally it is provided that an air preparation arrangement is provided which comprises an air pre-heating system, an air filtering system, an air humidifying system and/or an air dehumidifying system.

Optionally it is provided that a regulating arrangement is provided for regulating the temperature of the supplied air, for regulating the temperature of the removed combustion chamber gases, for regulating the baking chamber humidity and/or for regulating the baking chamber temperature.

Optionally it is provided that a regulating arrangement or a control arrangement is provided for regulating or controlling the volume flow of the convection fan(s).

Optionally it is provided that a regulating arrangement or a control arrangement is provided for regulating or controlling the heating power of the heating arrangement.

Optionally it is provided that a regulating arrangement is provided and that the regulating arrangement comprises at least one sensor, such as in particular a temperature sensor, a pressure sensor, a moisture sensor and/or a sensor for determining a volume flow of the convection flow of the convection fan or the convection fans.

Optionally it is provided that two or more convection fans are provided, which open into the baking chamber separately from one another at different points and that the convection fans can be controlled separately or can be regulated separately.

Optionally it is provided that a wall or a thermally insulated wall is provided between the baking chamber and the pre-head by means of which the baking chamber is substantially separated from the pre-head, wherein the wall has an inlet opening and an outlet opening for passage of the baking plates and wherein the openings are preferably configured to be as small as possible so that any escape of the baking chamber gas into the pre-head is largely minimized.

Preferably the baking oven comprises at least one convection fan. This convection fan produces a gas flow, in particular a convection flow in the interior of the baking chamber. Through this gas flow or the convection flow, on the one hand the heat introduced into the baking chamber can be better utilized. Furthermore, due to the convection flow the heat is distributed better in the baking chamber with the result that the baking quality is improved.

Optionally it is provided that the convection flow runs substantially along the main direction of movement of the baking tongs. According to a preferred embodiment, the baking tongs are moved through the baking chamber and through the pre-head along two substantially horizontally running surfaces. Thus, the main direction of movement of the baking tongs mostly corresponds to these transport planes. Furthermore, the endless conveyor preferably comprises a front deflection point and a rear deflection point. The rear deflection point is that region of the baking chamber in which the endless conveyor is deflected, in particular by 180° in order to be guided back in the direction of the pre-head. The front deflection point usually lies in the pre-head and corresponds to that region in which the endless conveyor is again deflected by 180° in the direction of the baking chamber.

In the pre-head an opening zone for opening the baking tongs, a baked product removal zone for removal of the baked products, a baking mass application zone for application of the baking mass and a closing zone for is closing the baking tongs are provided consecutively along the conveying direction of the baking tongs. The baking tongs closed in the closing zones, which each form a baking mould, are subsequently conveyed through an inlet opening into the baking chamber. After the rear deflection point the baking tongs are preferably transported back again in the direction of the pre-head where they emerge from the baking chamber through an outlet opening and at the same time enter into the pre-head.

Optionally the extractor opens into the baking chamber in the region of the pre-head. This means that the opening is located near the pre-head and in particular that it is arranged at a distance from the rear deflection point. As a result, the convection flow, starting from the convection fan, can flow through almost the entire baking chamber before it exits through the extractor. Preferably the convection fan is therefore provided on one side of the baking chamber and the extractor on the other side. Optionally the extractor opens into the evaporation zone of the baking chamber. Optionally the extractor opens into the baking chamber at a distance from the evaporation zone.

Optionally the device comprises a control and/or regulating arrangement. For example, by regulating the drive of the convection fan, the convection in the baking chamber can be regulated to an optimal value. For example, the baking chamber temperature can be thereby regulated. For example, the exhaust gas temperature can be thereby regulated. Also the heating arrangement and in particular the heating power of the heating arrangement can be regulated or controlled by one or by the regulating arrangement.

Furthermore, the baking oven according to the invention optionally comprises an air preparation arrangement. This air preparation arrangement is in particular suitable or adapted to prepare the air to be introduced by the convection fan. This preparation can for example be an air pre-heating. The air preparation system optionally comprises an air filtering system, an air dehumidifying system, an air humidifying system and/or an air temperature control system. The air preparation arrangement can be used as part of the control section or as part of the regulating arrangement in order to improve the efficiency and the baking quality.

Optionally at least one sensor is provided whose data or measurement data can be used as input quantities of the regulating arrangement or for control. Optionally a sensor is provided for measuring the volume flow of the convection flow introduced by the convection fan. Optionally the temperature of the supplied air is regulated by the regulating arrangement. Optionally the moisture of the supplied air is regulated by the regulating arrangement. Optionally a plurality of convection fans are provided which open into the baking chamber at different points. Optionally, the convection fans can be regulated and/or controlled independently of one another.

By means of the provision of temperature sensors at a desired point, for example, in the region of the extractor, in the region of the baking chamber or in the region of the convection fan, the temperature at these points can be varied for example by controlling the fan, via the air pre-heating or via the air moisture or it can be regulated by the regulating arrangement.

Optionally in all embodiments it is provided that the convection fan is adapted for supplying fresh air. In particular, it can be provided that the supplied fresh air is free from combustion gases or baking chamber gases. Optionally it is provided that the convection fan opens into the baking chamber separately from the heating arrangement and in particular at a distance from the heating arrangement. Optionally it is provided that in all embodiments the extractor fan is regulated and/or controlled.

Subsequently the invention is further described by means of the figures.

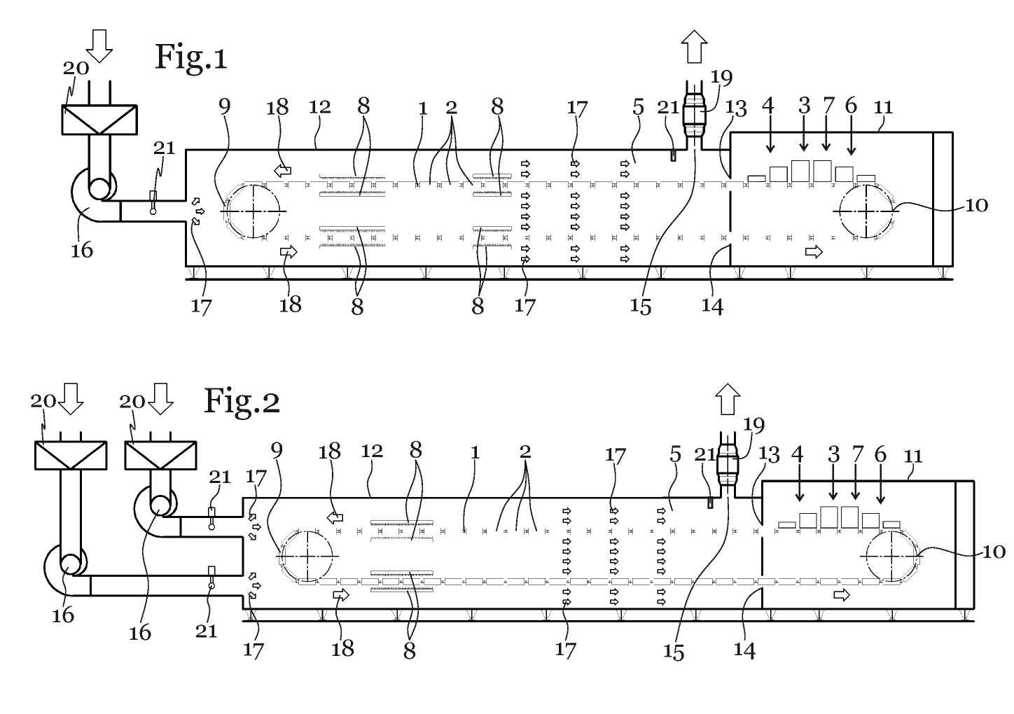

FIG. 1 shows a schematic cutaway side view of an embodiment of a baking oven according to the invention.

FIG. 2 shows a schematic cutaway side view of another embodiment of a baking oven according to the invention.

Unless specified otherwise, the reference numbers correspond to the following components:

endless conveyor 1, baking tong 2, baking mass application zone 3, closing zone 4, baking chamber 5, opening zone 6, baked product removal zone 7, heating arrangement 8, rear deflection point 9, front deflection point 10, pre-head 11, thermal insulation 12, inlet opening 13, outlet opening 14, extractor 15, convection fan 16, convection flow 17, main direction of movement (of the baking tongs) 18, extractor fan 19, air preparation arrangement 20, sensor 21.

FIG. 1 shows a schematic side view of an embodiment of a baking oven according to the invention. An endless conveyor 1 with baking tongs 2 is preferably moved continuously through a baking chamber 5 and through a pre-head 11. The baking tongs 2 which are fixed or can be fixed on the endless conveyor 1 are configured to be openable and closable. A baking mould in which the baking mass is baked in the baking chamber is formed between the two baking plates of a baking tong.

After passing through the baking chamber, the baking tong is conveyed into the pre-head 11 where it is opened in a first step in an opening region 6. In the following product removal zone 7 the baked product is removed from the opened baking tong 2 and transported away. In the following baking mass application zone 3 the baking tong 2 is again loaded with a baking mass. In the following closing zone 4 the baking tong 2 is again closed and conveyed in this closed position through the baking chamber 5. Optionally in all embodiments a locking device can be provided for locking the baking tongs. In particular for wafer products having a crispy-brittle consistency which are baked at high pressure and high temperature, such a locking device is necessary.

After closure of the baking tong 2, the baking tong 2 is conveyed along the endless conveyor 1 through an inlet opening 13 into the baking chamber 5. Directly after entry of the baking tong 2 into the baking chamber 5, the baking tong 2 passes through an evaporation zone. In this evaporation zone large parts of the volatile components of the baking mass are evaporated, with the result that a high gaseous volume flow emerges from the baking tong in this region. Preferably in all embodiments the extractor 15 opens into this evaporation zone of the baking chamber 5 so that the volatile components emerging from the baking tong 2 can be removed immediately by the extractor 15. In particular the extractor 15 comprises an extractor fan 19 which can extract the hot baking chamber gas from the baking chamber 5.

The baking chamber 5 is preferably provided with a thermal insulation 12. This thermal insulation 12 can in all embodiments substantially completely surround the baking chamber so that the effect of the thermal insulation 12 is optimized. The baking chamber walls and in particular the thermal insulation 12 however comprise inlet and outlet openings to the necessary extent. In particular, the baking tongs 2 must emerge through the outlet opening 14 and can enter through the inlet opening 13. The output of the convection fan 16 also enters through the wall of the baking chamber and therefore also through the thermal insulation 12 into the baking chamber 5.

Optionally further openings are provided in order to supply the heating arrangement 8 with fuel. The heating arrangements 8 can in all embodiments preferably comprise or be radiant heating devices such as, for example, wire mesh burners or porous burners. Optionally conventional burners are combined with radiant heating devices. Optionally only radiant heating devices are provided. These radiant heating devices are preferably operated with a pre-mixed gas-air mixture. This gas-air mixture is preferably burnt in a porous body such as, for example, in a metal foam, a ceramic foam or in a wire mesh. In all embodiments the heating arrangement 8 can be provided between the extractor 15 and the rear deflection point 9 of the endless conveyor. For example, the heating arrangement 8 can be arranged in the rear third of the baking chamber 5, in the rear half of the baking chamber 5 or in a large part of the baking chamber 5. In all embodiments in a baking oven that part located in the area of the rear deflection point 9 is designated as “rear”. The front region of the baking oven is in particular the region of the pre-head 11 and optionally the region in which the front deflection point 10 is also arranged.

The front deflection point 10 and the rear deflection point 9 correspond to those regions of the endless conveyor in which it is deflected. The deflection takes place, for example, via wheels, rotary frames, rollers or similar.

According to the invention, a convection fan 16 is provided. This convection fan 16 is in particular configured as an air blower and through the introduction of air produces an artificial convection flow 17 which flows through the baking chamber 5.

According to FIG. 1, the convection fan 16 opens through the rear end wall of the baking chamber 5 or the baking oven and in particular in the region of the rear deflection point 9 into the baking chamber 5. In all embodiments the convection flow 17 can substantially follow the main direction of movement 18 of the baking tongs 2, wherein optionally the baking tongs are moved against the convection flow 17 or with the convection flow 17. In particular, the convection flow 17 runs substantially horizontally through the baking chamber 5. In order to achieve a complete and uniform flow through the baking chamber 5, the extractor 15 is preferably arranged on one side of the baking chamber 5 and the opening of the convection fan 16 on the other side.

is According to an embodiment not shown however, the extractor 15 can also be provided in the rear zone and the opening of the convection fan 16 in the area of the pre-head 11.

In all the embodiments, an air preparation arrangement 20 can be provided. This air preparation arrangement 20 can for example comprise an air pre-heating device, an air filtering device, an air dehumidifying device or an air humidifying device. Optionally a plurality of said possibilities for air preparation can be used jointly or consecutively.

Optionally a sensor 21 or a plurality of sensors 21 are provided. For example, a temperature sensor, an air mass meter, a volume flow meter and/or a moisture meter are used. The data of these sensors 21 can be used for example to bring about an optimal regulation or control of the baking oven.

For example, one temperature sensor can be provided in the region of the extractor 15 in order to regulate the exhaust gas temperature of the extracted combustion chamber gases. For example, the combustion chamber temperature can also be measured in order to be regulated. Optionally, the air flow produced by the convection fan 16 or the power of the convection fan can be varied to vary the combustion chamber temperature. Optionally the combustion chamber temperature can also be varied by varying the moisture of the introduced air.

Optionally the air in the air preparation arrangement 20 is pre-heated to regulate the baking chamber temperature or other temperatures.

The variation of the heating power of the heating arrangement 8 can be included to regulate the optimal baking parameters.

FIG. 2 shows another embodiment of a baking oven according to the invention in a schematic side view. The elements of the embodiment of FIG. 2 correspond to those of FIG. 1. Unlike the embodiment of FIG. 1, two convection fans 16 are provided in the embodiment of FIG. 2. These convection fans 16 open into the baking chamber 5 at different points. Preferably both convection fans 16 open in the region of the rear deflection point 9 or through the rear end side of the baking chamber 5 into the baking chamber 5. Preferably the two fans open into the baking chamber 5 one above the other. Optionally the two convection fans 16 can be controlled and/or regulated independently of one another.

Optionally in all embodiments each of the convection fans 16 has its own air preparation arrangement 20. These air preparation arrangements 20 can be designed differently or the same or can be controlled and/or regulated independently of one another.

1-16. (canceled)

17. A baking oven for producing baked or baked and edible products, the baking oven comprising:
an endless conveyor;
a plurality of openable and closable baking tongs disposed in a row along said endless conveyor and consecutively passing through:
a baking mass application zone for application of a baking mass to an opened baking tong;
a closing zone for closing said baking tongs;
a baking chamber for baking the baked products in said closed baking tongs, said baking chamber including a region having at least one heating configuration disposed in said baking chamber for heating said baking tongs;
an opening zone for opening said baking tongs; and
a baked product removal zone for removing the baked products from said opened baking tongs;
a pre-head;
a rear deflection point disposed in said baking chamber and a front deflection point disposed at a distance from said baking chamber in said pre-head, said endless conveyor and said baking tongs being deflected at said rear and front deflection points;
said baking chamber being substantially closed and having a thermal insulation, an inlet opening for entry of said baking tongs, an outlet opening for exit of said baking tongs and an extractor for extracting baking chamber gases;
at least one convection fan being at least one air blower opening into said baking chamber at a distance from said extractor, said at least one convection fan introducing or being configured to introduce secondary air into said baking chamber in an open-loop or closed-loop controlled manner to produce artificial convection; and
said at least one convection fan producing a convection flow initially through an opening of said convection fan into said baking chamber, then through said region of said baking chamber having said at least one heating configuration and then through said extractor.

18. The baking oven according to claim 17, wherein said air blower of said at least one convection fan introduces or is configured to introduce only secondary air into said baking chamber in a closed-loop or open-loop manner to produce artificial convection.

19. The baking oven according to claim 17, wherein:
said at least one convection fan causes said convection flow to open into said baking chamber in a vicinity of said rear deflection point or through a rear end wall of said baking chamber; or
said at least one convection fan causes said convection flow to flow initially through said opening of said at least one convection fan into said baking chamber, then through said region of said baking chamber having said at least one heating configuration and then through said extractor; and
a convection zone is provided in which no heating configuration is provided between said region of said baking chamber having said at least one heating configuration and said extractor.

20. The baking oven according to claim 17, wherein said baking tongs move in a main direction of movement, and said convection flow in said baking chamber runs at least one of along said main direction of movement or substantially horizontally before exiting from said extractor.

21. The baking oven according to claim 17, wherein:
said baking tongs move in a main direction of movement;
said baking chamber has a side opposite said rear deflection point; and
said extractor opens into said baking chamber at a distance from said rear deflection point along said main direction of movement at least one of at said opposite side of said baking chamber or in a vicinity of said pre-head.

22. The baking oven according to claim 17, wherein said at least one heating configuration contains or is a radiant heating device or a wire mesh burner or a porous burner.

23. The baking oven according to claim 17, wherein said at least one heating configuration contains or is a radiant heating device or a wire mesh burner or a porous burner including a combustion zone for combustion of a pre-mixed air-fuel mixture including air being primary air for a combustion of fuel.

24. The baking oven according to claim 17, which further comprises an extraction fan for extracting the baking chamber gases through said extractor.

25. The baking oven according to claim 17, wherein said at least one convection fan includes two or more convection fans opening into said baking chamber separately from one another at different locations.

26. The baking oven according to claim 17, wherein:
said at least one convection fan includes two or more convection fans opening into said baking chamber separately from one another at different locations and opening into said baking chamber in a vicinity of said rear deflection point or through a rear end wall of said baking chamber; or
said at least one convection fan causes said convection flow to flow initially through openings of said at least one convection fan into said baking chamber, then through said region of said baking chamber having said at least one heating configuration and then through said extractor; and
a convection zone having no heating configuration is provided between said region of said baking chamber having said at least one heating configuration and said extractor.

27. The baking oven according to claim 17, which further comprises an air preparation configuration including at least one of an air pre-heating system, an air filtering system, an air humidifying system or an air dehumidifying system.

28. The baking oven according to claim 17, which further comprises a configuration for closed-loop control of at least one of a temperature of supplied air, a temperature of removed baking chamber gases, a baking chamber humidity or a baking chamber temperature.

29. The baking oven according to claim 17, which further comprises a configuration for closed-loop or open-loop control of a volume flow of said at least one convection fan.

30. The baking oven according to claim 17, which further comprises a configuration for closed-loop or open-loop control of a heating power of said at least one heating configuration.

31. The baking oven according to claim 17, which further comprises a closed-loop control configuration including at least one sensor.

32. The baking oven according to claim 31, wherein said at least one sensor is at least one of a temperature sensor, a pressure sensor, a moisture sensor or a sensor for determining a volume of said convection flow of said at least one convection fan.

33. The baking oven according to claim 17, wherein said at least one convection fan includes two or more convection fans opening into said baking chamber separately from one another at different locations, said convection fans being configured to be open-loop or closed loop controlled separately.
